(19) United States
(12) Patent Application Publication
(10) Pub. No.: US 2007/0126580 A1
(43) Pub. Date: Jun. 7, 2007

(54) Apparatus and method for reducing the risk of static induced damage of an radio frequency identification device

(75) Inventor: Joseph D. Roth, Springboro, OH (US)

Correspondence Address: Intellectual Property Section;Law Department, NCR Corporation, 1700 South Patterson Blvd., Dayton, OH, 45479-0001, US

(73) Assignee: NCR Corporation

(21) Appl. No.: 11/293,997

(22) Filed: Dec. 5, 2005

(51) Int. Cl. G08B 13/14

(52) U.S. Cl. 340/572.1; 340/572.7

(57) ABSTRACT

A radio frequency identification device includes a substrate, radio frequency identification circuitry carried by the substrate, and a static dissipative material positioned on the radio frequency identification device to promote dissipation of a static charge associated with the radio frequency identification device.

### FIELD OF THE INVENTION

The present invention relates to a method for reducing the risk of static induced damage of an radio frequency identification (“RFID”) inlays.

The invention has been primarily developed for use with adhesive RFID tags carrying RFID inlays. However, the invention is by no means restricted to that field of use, and is also applicable to protecting RFID circuitry in a broader context.

### BACKGROUND

RFID devices are widely used, and are commonly found in the form of an RFID tag. In common scenarios, a RFID tag is used as a label on an item of commerce to facilitate wireless identification of that item. A RFID tag typically includes a substrate, such as a sheet of label facestock, with a RFID inlay mounted thereon. The typical inlay includes RFID circuitry (i.e. a silicon chip electronically coupled to an antenna) mounted on a carrier substrate. Typically the tag includes an adhesive surface that is releasably adhered to a release liner for storage, and subsequently adhered to a selected item of commerce.

The contact and separation of two materials creates electrostatic charge, known as triboelectric charging. Electrostatic discharge (ESD) is a rapid transfer of electrostatic charge generated by triboelectric charging. RFID tags are often subject to triboelectric charging—for example when removing an adhesive RFID tag from a release liner. ESD is known to cause static induced damage RFID inlays.

### SUMMARY

It is an object of the present invention to overcome or ameliorate at least one of the disadvantages of the prior art, or to provide a useful alternative.

According to a first aspect of the invention, there is provided a radio frequency identification device which includes a substrate; radio frequency identification circuitry carried by the substrate; and a static dissipative material positioned on the radio frequency identification device to promote dissipation of a static charge associated with the radio frequency identification device.

According to a second aspect of the invention, there is provided a method for reducing the risk of static induced damage of radio frequency identification circuitry, the method including the steps of: providing a substrate including a surface having a surface resistivity within a predetermined static dissipative range; and mounting the radio frequency identification circuitry to the substrate.

According to a third aspect of the invention, there is provided an radio frequency identification tag including: an radio frequency identification inlay; a substrate for carrying the inlay; and a static dissipative material positioned to promote dissipation of static charge arising on a surface of the substrate or the inlay.

According to a further aspect of the invention, there is provided a release liner for releasably adhesably carrying at least one radio frequency identification tag, the liner including: a first side for carrying the at least one radio frequency identification tag; and a second side having a static dissipative surface.

### BRIEF DESCRIPTION OF THE DRAWINGS

The benefits and advantages of the present invention will become apparent to those skilled in the art to which this invention relates from the subsequent description of exemplary embodiments and the appended claims, taken in conjunction with the accompanying drawings, in which:

FIG. 1 is a perspective view of an RFID tag according to an embodiment of the invention;

FIG. 2 a perspective view of the underside of the tag of FIG. 1;

FIG. 3 illustrates the tag of FIG. 1 releasably adhered to a release liner, the liner being spooled onto a reel; and

FIGS. 4 to 9 are schematic sectional views of tags according to alternate embodiments.

### DETAILED DESCRIPTION

Referring to the drawings, it will be appreciated that, in the different figures, corresponding features have been denoted by corresponding reference numerals.

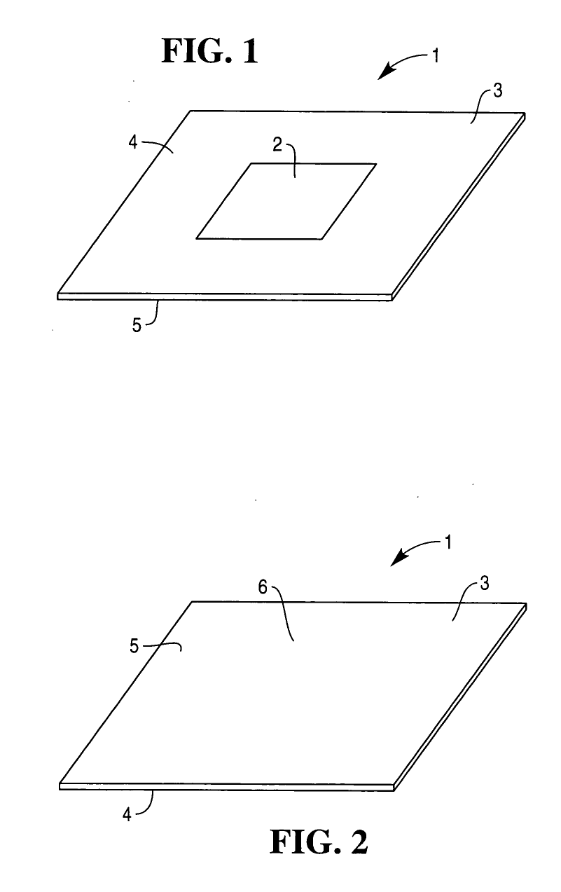

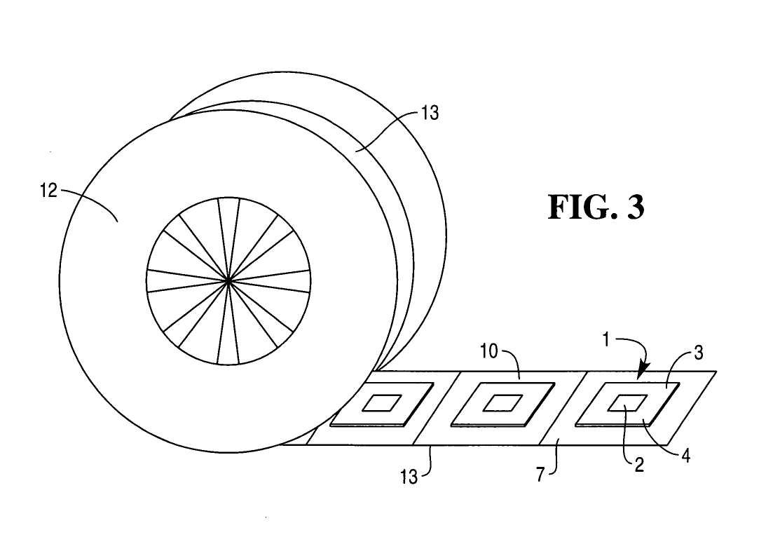

Referring initially to FIGS. 1 and 2, there is provided an RFID device, in the form of a RFID tag 1, including an RFID inlay 2. A substrate 3 carries inlay 2. In some embodiments, RFID circuitry is mounted directly to the substrate and no inlay is required.

Substrate 3 includes static dissipative material positioned to promote dissipation of static charge arising on a surface of the substrate or the inlay. In particular, substrate 3 has two oppositely directed outer surfaces 4 and 5, and at least one of these surfaces is static dissipative. In the embodiment of FIG. 1, both of surfaces 4 and 5 are static dissipative.

In the present embodiment, substrate 3 is formed substantially of paper, although plastics or a combination of materials are used in other embodiments. Generally speaking, materials and constructions for RFID tags will be known to those skilled in the art. That being said, known materials and constructions are modified in accordance with embodiments of this invention. In the case of tag 1, surface 4 is coated with a static dissipative coating to provide static dissipative surface qualities. Although FIG. 1 illustrates inlay 2 as externally visible, it will be appreciated that this is for the purposes of schematic representation only, and in some embodiments substrate 3 includes a layer covering inlay 2.

Substrate 3 also includes a pressure sensitive adhesive (PSA) 6 on surface 5. This PSA affixes tag 1 to a suitable release liner in the first instance, and is subsequently used to attach the tag to an item: for example a pallet carrying a consignment of goods, a consumer item, or another selected item. PSA 6 is static dissipative and defines static dissipative surface 5. Suitable static dissipative PSAs include conductive PSAs having a decreased concentration of conductive filler, or non-conductive PSAs having an increased concentration of conductive filler. Relevant conductive fillers include, but are not limited to, powders derived from one or more of the materials from the following list: carbon; nickel-coated graphite; silver-coated glass; silver-coated copper; silver-coated nickel; silver-coated aluminum; silver; and gold.

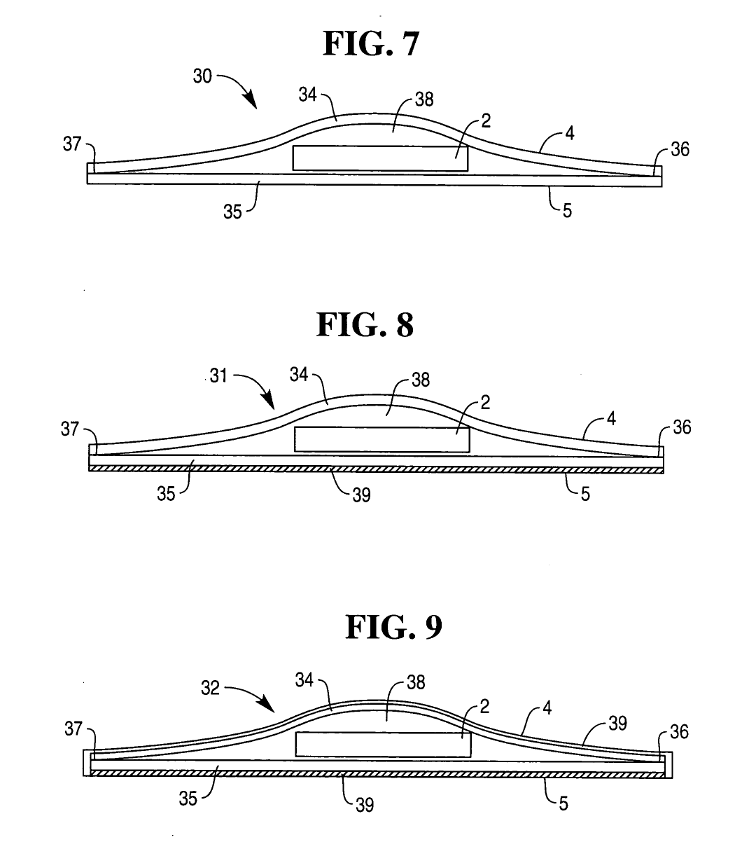

In other embodiments alternate tags having differing substrate constructions are used to achieve static dissipative surfaces. Exemplary tags are illustrated in FIGS. 4 to 9, and are described in greater detail further below. For example, in some embodiments substrate 3 is formed from a static dissipative material. In some embodiments the substrate includes a release liner.

For the purpose of this disclosure, the term static dissipative denotes a surface resistivity of between about 10⁵ Ohms/sq and 10¹² Ohms/sq. However, in some embodiments it is preferable to have surface resistivities of between about 10⁸ Ohms/sq and 10¹² Ohms/sq, or more preferably between about 10⁸ Ohms/sq and 10¹⁰ Ohms/sq.

In practice, it is advantageous to perform some analysis to determine a suitable static dissipative range, defined in terms of surface and volume resistivities. The rationale is that the resistivity of substrate 3 affects the gain and performance of tag 1. In one embodiment, the gain of an RFID inlay is measured, shielding effects of conductive coverings being applied to the inlay are analyzed, and subsequently resistivity ranges are selected on the basis of the analysis.

Substrates used for known RFID tags are typically insulators such as paper or plastic. Moreover, PSAs previously known to be used with RFID tags are insulators.

Insulators have high electrical resistances—typically translating to surface resistivities in excess of 10¹² Ohms/sq. This high resistance prevents electrostatic charge from moving across the surface or through the insulator. A large amount of charge is therefore able to reside on the surface of an insulator. It is possible for both positive and negative charges to reside on the surface of an insulator provided they are in different locations.

For the purposes of this specification, the terms “insulator” and “non-conductive material” are used interchangeably.

Conductive materials have a very low electrical resistance, which typically translates to a surface resistivity of less than 10⁵ Ohms/sq. This allows electrons to flow across the surface of the material and through the interior of the material. When a conductive becomes charged, for example as a result of triboelectric charging, the charge is distributed across the surface of the material. If the material is then grounded ESD occurs. Further, a conductive material cannot have both positive and negative charge on the surface at the same time. Triboelectric charge can exist on a conductor provided it is not grounded.

By using a substrate 3 having static dissipative surfaces 4 and 5, any net charge accumulated at these surfaces flows, upon ESD, at a relatively slow rate such that the risk of static induced damage to inlay 2 is reduced. Coating both surfaces 4 and 5 is advantageous as it provides a direct and simple path for any separated charges to recombine. However, coating of a single surface promotes sufficient dissipation of static charge to reduce risk to an extent.

In cases where surfaces 4 and 5 have a resistivity below a given threshold, inlay 2 is to an extent shielded from interrogation or modification by radio frequency fields, as, those field are distorted by the surfaces. It will be appreciated that this directly affects the functionality of the RFID inlay. As such, coatings, substrate materials and/or adhesives are selected having respective resistivities low enough to suitably dissipate static but high enough to allow the RFID functionality. The precise threshold will be dependant on the interrogation frequency and the type of RFID antenna present in inlay 2. Other factors, such as read direction, also play a role. As such, it will be appreciated by a skilled addressee, from the teaching herein, that resistivity values should be selected such that inlay 2 is tuned for interrogation under the specific configuration that is to be implemented.

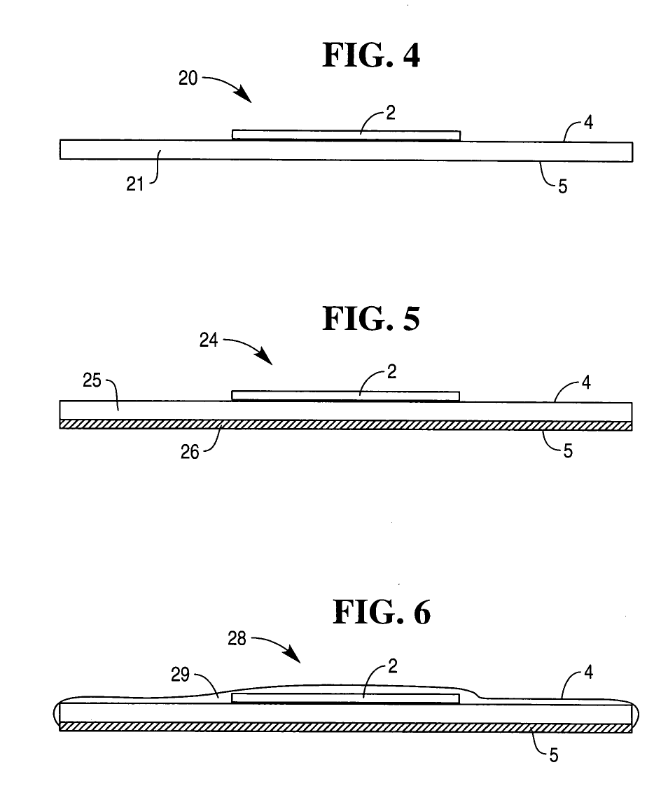

As shown in FIG. 3, a plurality of tags, such as tag 1, are releasably adhered to a first side 10 of an elongate release liner 7. Depending on the specific application, the tags are either like, sequentially arranged along the length of liner 7, or randomly arranged.

For convenient storage, transportation and dispensing liner 7 is rolled onto a spool reel 12. Although the tags are shown to reside on side 10 of liner 7, it is appreciated that in some embodiments the tags reside on the opposite side 13.

Whilst the above approach reduces the risk of static induced damage to a particular inlay 2, there is a residual risk relating to other tags affixed on liner 7. For example, as a tag 1 is removed from liner 7, triboelectric charging results in static charge being accumulated on liner 7 as well as tag 1, which places the remaining tags at risk of static induced damage. Further, as liner 7 is unwound on reel 12, triboelectric charging occurs due to the separation of surface 4 from the side 13 of liner 7.

To reduce the risk of static induced damage of tags adhered to liner 7, one or more static dissipative layers are incorporated into liner 7. In the present embodiment liner 7 is formed of a single silicon elastomer layer containing an electrically conductive powder. The powder typically includes any one or more of carbon, nickel-coated graphite, silver-coated glass, silver-coated copper, silver-coated nickel, silver-coated aluminum, silver, and gold. The type and quantity of conductive filler used controls the surface and volume resistivity of liner 7. Alternate static dissipative silicone elastomers are used in other embodiments, such as those used to form gaskets for EMI shielding applications. Preferably, the surface resistivity of liner 7 is between about 10⁵ Ohms/sq and 10¹² Ohms/sq. However, in embodiments it is preferable to have surface resistivities of between about 10⁸ Ohms/sq and 10¹² Ohms/sq, or more preferably between about 10⁸ Ohms/sq and 10¹⁰ Ohms/sq.

The use of silicone static dissipative elastomer is particularly advantageous given the pathways provided for charge to dissipate. However, in other embodiments, a static dissipative coating is used as an alternative.

It is noted that an overly conductive silicone layer will shield inlay 2 from a radio frequency signal used for programming and/or interrogation. In some embodiments liner 7 is selected such that it has a surface resistivity that is low enough to dissipate any accumulated static charge but high enough to allow the inlay to function properly. In other embodiments programming and/or interrogation of the inlay is only performed when the tag is separated from liner 7.

FIGS. 1 to 3 illustrate four distinct surfaces that are susceptible to triboelectric charging. These are surfaces 4 and 5 of substrate 3, as well as sides 10 and 13 of liner 7. In the present embodiment all of these surfaces are static dissipative to reduce the risk of static induced damage of inlay 2. However, in other embodiments, a selection or a single surface is static dissipative. A number of alternate tags are described below by reference to the schematic sectional views of FIGS. 4 to 9. These figures are not to scale, and are provided to schematically illustrate the layers included within the embodiments.

Tag 20 of FIG. 4 has a substrate 3 in the form of a paper label 21. Inlay 2 includes a silicon chip and an antenna bonded to label 21. The antenna is formed of a conductive ink which is printed to surface 4 of label 21. In this embodiment, the paper of label 21 is infused with conductive carbon filler pre-treated to provide static dissipative qualities. As such, both surfaces 4 and 5 are static dissipative, although inlay 2 projects above surface 4.

Tag 24 of FIG. 5 also has a substrate 3 formed of a paper label 25 and static dissipative PSA 26. In this embodiment, label 25 is not static dissipative, and as such only surface 5 is static dissipative. In some embodiments a static dissipative label is used in conjunction with PSA 26.

Tag 28 of FIG. 6 is similar to tag 24, however a static dissipative coating 29 is applied to surface 4 and inlay 2. Coating 29 extends beyond surface 4 and conductively connects with PSA 26 to assist dissipation of static charge between surfaces 4 and 5.

FIGS. 7 to 9 respectively illustrate tags 30 to 32 each having two laminar plastics layers 34 and 35. Layers 34 and 35 are heat sealed at ends 36 and 37. In construction, inlay 2 is first printed and/or mounted to layer 34, and layer 35 is subsequently heat sealed such that inlay 2 is contained within a packet 38.

In the case of tag 30, layers 34 and 35 are each formed of static dissipative plastics. In the present embodiment a typically non-conductive plastic infused with carbon powder is used. Tag 31 is formed of non-conductive plastics layers 34 and 35, however a static dissipative PSA 39 is applied to define surface 5. Tag 32 is similar to tag 31, however substrate 3 includes a static dissipative coating 39.

It will be appreciated that combinations and variations of the above examples also produce suitable tags. For example, tags having static dissipative coatings defining both surfaces 4 and 5, or tags combining static dissipative coatings with static dissipative laminar sheets. In some embodiments a coating is applied only to inlay 2.

Although the present invention has been described with particular reference to certain preferred embodiments thereof, variations and modifications of the present invention can be effected within the spirit and scope of the following claims.

What is claimed is:

1. A radio frequency identification device comprising:
a substrate;
radio frequency identification circuitry carried by the substrate; and
a static dissipative material positioned to promote dissipation of a static charge associated with the radio frequency identification device.

2. A radio frequency identification device according to claim 1, wherein the static dissipative material is positioned on the substrate.

3. A radio frequency identification device according to claim 2, wherein the substrate includes two surfaces, the static dissipative material being disposed on a least one of the two surfaces.

4. A radio frequency identification device according to claim 3, wherein both of the two surfaces have the static dissipative material disposed thereon.

5. A radio frequency identification device according to claim 4, wherein the two surfaces are conductively connected via the static dissipative material.

6. A radio frequency identification device according to claim 1, wherein the static dissipative material is distributed throughout the substrate.

7. A radio frequency identification device according to claim 1, wherein a surface of the substrate is coated with the static dissipative material.

8. A radio frequency identification device according to claim 1, where the static dissipative material is in the form of a static dissipative adhesive applied to a surface of the substrate.

9. A radio frequency identification device according to claim 8, wherein the static dissipative adhesive is a conductive adhesive having a reduced concentration of conductive filler.

10. A radio frequency identification device according to claim 8, wherein the static dissipative adhesive is a non-conductive adhesive having an increased concentration of conductive filler.

11. A radio frequency identification device according to claim 1 wherein the static dissipative material has a surface resistivity of between about 10⁵ Ohms/sq and 10¹² Ohms/sq.

12. A radio frequency identification device according to claim 1 wherein the static dissipative material has a surface resistivity of between about 10⁸ Ohms/sq and 10¹² Ohms/sq.

13. A radio frequency identification device according to claim 1 wherein the static dissipative material has a surface resistivity of between about 10⁸ Ohms/sq and 10¹⁰ Ohms/sq.

14. A radio frequency identification device according to claim 1 being releasably adhered to a first side of a release liner, the liner having a static dissipative second side oppositely directed in relation to the first side.

15. A radio frequency identification device according to claim 1 wherein the substrate includes a release liner and wherein the release liner includes the static dissipative material.

16. The radio frequency identification device according to claim 1, wherein the radio frequency identification circuitry is part of an inlay and wherein the inlay includes the static dissipative material.

17. A release liner for releasably adhering at least one radio frequency identification tag, the liner comprising:
a first side for carrying the at least one radio frequency identification tag; and
a second side having a static dissipative surface.

18. A release liner according to claim 17, wherein the release liner is elongate and includes a plurality of radio frequency identification tags.

19. A release liner according to claim 17, wherein the second side includes a static dissipative coating.

20. A release liner according to claim 17, wherein the second side has a surface resistivity of between about 10⁵ Ohms/sq and 10¹² Ohms/sq.

21. A method for reducing the risk of static induced damage of radio frequency identification circuitry, the method comprising the steps of:
providing a substrate including a surface having a surface resistivity within a predetermined static dissipative range; and
mounting the radio frequency identification circuitry to the substrate.

22. A method according to claim 21, wherein the radio frequency identification circuitry is mounted inside the substrate.

23. A method according to claim 21, wherein the substrate is a release liner to which an radio frequency identification tag carrying the radio frequency identification circuitry is releasably adhered.

24. A method according to claim 21, including the steps of:
determining the gain of the radio frequency identification circuitry;
analyzing shielding effects of conductive coverings on the radio frequency identification circuitry; and
selecting the predetermined range on the basis of the analysis.
